(19) United States
(12) Patent Application Publication
(10) Pub. No.: US 2005/0243685 A1
(43) Pub. Date: Nov. 3, 2005

(54) Optical pickup apparatus and optical disc drive

(76) Inventor: Shigeru Oouchida, Tokyo (JP)

Correspondence Address: DICKSTEIN SHAPIRO MORIN & OSHINSKY LLP, 2101 L Street, NW, Washington, DC, 20037, US

(21) Appl. No.: 11/103,487

(22) Filed: Apr. 12, 2005

(30) Foreign Application Priority Data
Apr. 13, 2004 (JP) 2004-117769

(51) Int. Cl. G11B 7/00

(52) U.S. Cl. 369/112.1

(57) ABSTRACT

A compact optical pickup apparatus can retrieve information from plural kinds of optical discs, using a hologram which has four divided sub regions. The present invention also relates to a small size optical disc drive for accessing stable plural kinds of optical discs.

### BACKGROUND OF THE INVENTION

1. Field of the Invention

The present invention generally relates to an optical pickup apparatus, and an optical disc drive, and especially relates to an optical pickup apparatus and an optical disc drive comprising an optical pickup apparatus in which light is irradiated on an optical disc, and which receives reflection light from the optical disc.

2. Description of the Related Art

Optical discs such as CD (compact disc) or DVD (digital versatile disc) attracted attention as information recording media to record data, and an optical disc drive is known for data recording. With advancements of personal computers (PCs), it has become possible to deal with AV (Audio-Visual) information, such as music and images. Since the amount of the AV information is very large, optical discs, such as a CD (compact disc), and a DVD (digital versatile disc) capable of recording about 7 times as much data as the CD on a disc of the same diameter as the CD, come to attract attention as an information recording medium. With the prices of CDs and DVDs having dropped, optical disk apparatuses capable of handling CDs and DVDs are of interest. Here, as an optical disc of the CD system, CD-ROM, CD-R (CD-Recordable), CD-RW (CD-ReWritable), etc., are marketed; and as for the DVD system, DVD-ROM, DVD-RAM, DVD-R (DVD-Recordable), DVD-RW (DVD-ReWritable), DVD+R (DVD+Recordable), DVD+RW (DVD+ReWritable), etc., are marketed.

The optical disc drive is usually equipped with an optical pickup apparatus. The optical pickup apparatus emits a laser beam to the recording surface of an optical disk to form a small light spot thereon, and receives a reflected laser beam from the recording surface of the optical disk.

The optical pickup device usually includes an object lens, an optical system and a photodetector. The optical system transmits the laser beam emitted by the light source to the recording surface of the optical disc, and transmits the return laser beam reflected from the recording surface of the optical disc to a predetermined light-receiving position where the photodetector is arranged. In response to the received laser beam, the photodetector outputs the electrical signal indicating the reproduced information of data that is recorded in the optical disc. Also, the optical pickup device outputs the signal including information (address information on the optical disc) required for the position control of the optical pickup device itself and the object lens.

DVD-ROM is used exclusively to retrieve information. DVD-R or DVD+R is recordable once. DVD-RW or DVD+RW is rewritable. Thus, it is preferable to be able to support an optical disc of different kinds of a standard as an optical disc drive.

For example, address information is included in DVD+R and DVD+RW (DVD+R/RW) by phase modulated part in wobbling shape of a track on the optical disc. And also address information is included in DVD-R and DVD-RW (DVD-R/RW) by land pre-pit part on the optical disc. In other words, it is necessary for precision to detect a phase modulated part accurately to access DVD+R/RW. And it is necessary for precision to detect a land pre-pit accurately to access DVD-R/RW. In addition, a phase modulated part and a land pre-pit part are extracted from the wobble signal that information with regard to wobbling shape of a track is included both. However, as for the land pre-pit part, the S/N ratio is smaller than a phase modulated part.

Therefore, it is necessary to generate the various signals which meet a standard of each to support an optical disc of different kinds of a standard with one optical pickup apparatus.

Furthermore, it is known to use information machinery which can be carried, including notebook-sized personal computers. These become the important factor that size, weight or depthwise of information machinery. With it, the request for reducing size, weight and depth become severe year by year. And miniaturization and reducing weight of an optical pickup apparatus become required. In order to satisfy a demand, an optical pickup apparatus is suggested. For example, refer to Japanese Laid-Open Patent Application 9-161282, in which a return light of the laser beam from an optical disc is divided into three laser beams with a hologram. One of the laser beams is used for generating a focusing error signal. The two other laser beams are used for generating a wobble signal.

However, there is a weak point in the prior art. In the optical pickup apparatus, the focusing error signal is generated using half of return light of the laser beam, and also the wobble signal is generated using the other half of return light of the laser beam. It is possible to detect a phase modulated part from this wobble signal with good precision. But it is difficult to detect a land pre-pit part from this wobble signal with good precision. In other words, it is difficult to operate both with DVD+R/RW and DVD-R/RW. In addition, a tracking error detecting device is described in Japanese Laid-Open Patent Application 10-269588, for example. The tracking error detecting device uses a return light of the laser beam divided into four laser beams by a hologram.

An object of the present invention is to provide a compact optical pickup apparatus for use with plural kinds of optical discs.

Another object of the present invention is to provide a compact optical disc drive for accessing plural kinds of optical discs with stability.

### SUMMARY OF THE INVENTION

Accordingly, it is a general object of the present invention to provide an optical pickup apparatus and an optical disc drive that substantially obviate one or more of the problems caused by the limitations and disadvantages of the related art.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by an optical pickup apparatus and an optical disc drive particularly pointed out in the specification in such full, clear, concise, and exact terms as to enable a person having ordinary skill in the art to practice the invention. To achieve these and other advantages and in accordance with the purpose of the invention, as embodied and broadly described herein, the invention provides as follows.

The present invention provides an optical pickup apparatus configured to access an optical disc including a recording layer including a wobbled spiral or concentric track comprising a light source, an object lens which focuses a laser beam emitted by the light source to the recording layer of the optical disc, a hologram which includes four sub regions divided by a first dividing line which has a first direction corresponding to the radial direction of the optical disc, and a second dividing line which has a second direction orthogonal to the dividing line of the optical disc, a photo detector which includes plural light receiving elements receiving diffracting light from each the sub region in the hologram and generating plural receiving light signal corresponding to each amount of receiving light; and an information signal generating apparatus which generates an information signal including address information of the optical disc using the receiving light signal corresponding to the each four sub regions.

In this manner, in the case where the laser beam emitted from the light source is focused to the recording layer on the optical disc through the object lens, the return light of the laser beam reflected back with the optical disc and through the object lens is deflected at the hologram having four sub regions divided by a first dividing line which has the radial direction of the optical disc and a second dividing line which is orthogonal to the first dividing line of the optical disc. The diffracted light from each sub region is received with plural light receiving elements composing the photo detector individually. The information signal generating apparatus generates the wobble signal from a difference with a sum signal of a receiving light signal corresponding to the four sub regions. In the conventional art, the information signal generating apparatus generates a signal including the address information using half of the return light of the laser beam. But in the present invention, because the information signal generating apparatus generates a signal including the address information using almost all of the return light of the laser beam, a S/N ratio of the generated signal is higher. Therefore, it becomes possible to detect the address information in the optical disc with high accuracy for plural kinds of the optical disc.

In above described case, it is possible to make the information signal include address information to a wobble signal.

In above described case, it is possible that the wobble signal is generated from a difference with a sum signal of the receiving light signal corresponding to the two sub regions allocated in one side of the second dividing line and a sum signal of the receiving light signal corresponding to the two sub regions allocated in the other side of the second dividing line.

In above described case, it is possible that the optical disc is a multi-layer optical disc including plural recording layers, wherein the hologram has a particular area which deflects a return light from the recording layer which is located farther from the object lens than an accessing recording layer to different direction compared with the four sub regions, or which is through a return light from the recording layer which is located farther from the object lens than an accessing recording layer to different direction compared with the four sub regions.

In above described case, it is possible that a size of the particular area is bigger than a spot diameter of the return light from the recording layer which is located farther from the object lens than the accessing recording layer on the hologram.

In above described case, it is possible that the information signal generating apparatus generates a signal including retrieved information from the optical disc using a sum signal of each the receiving light signal corresponding to the four sub regions.

In above described case, it is possible that the photo detector comprises a light receiving element to receive a laser beam which through over the particular area or which is deflected by the particular area, and the information signal generating apparatus generates a signal including a retrieved information from the optical disc using a sum signal of each the receiving light signal corresponding to the four sub regions and a receiving light signal corresponding to the particular area.

In above described case, it is possible that the light source and the photo detector are packed for one package.

In above described case, it is possible that a distance from the light receiving element receiving the laser beam which through over the particular area or which is deflected by the particular area to the light source is different with a distance from each the plural light receiving elements receiving diffracting light from each of the sub region to the light source.

In above described case, it is possible that two of the plural light receiving elements receiving the receiving light signal corresponding to the two sub regions allocated on one side of the second dividing line each have two sub light receiving elements dividing the first dividing line, and generate a receiving light signal corresponding to the amount of receiving light for each sub light receiving element, and the information signal generating apparatus generates a signal including a position gap information of the object lens related to focusing direction.

In above described case, it is possible that the two sub regions allocated on one side of the second dividing line are smaller than the two sub regions allocated in the other side of the second dividing line.

In above described case, it is possible that the information signal generating apparatus generates a signal including a position gap information of the object lens related to radial direction of the optical disc using a difference with a sum signal of two receiving light signals corresponding to two of the sub regions allocated in one side of the second divided line and a sum signal of two receiving light signals corresponding to two of the sub regions allocated on the other side of the second divided line.

In above described case, it is possible that the hologram is a polarizing hologram in which the diffraction efficiency is different depending on the polarized light direction of light incident on the hologram.

In above described case, it is possible that the information signal generating apparatus generates a signal including an information about phase difference between a sum signal of a light receiving signal corresponding to the sub region allocated in one side of the first dividing line and one side of the second dividing line and a light receiving signal corresponding to the sub region allocated on the other side of the first dividing line and the other side of the second dividing line and a sum signal of a light receiving signal corresponding to the sub region allocated on the other side of the first dividing line and one side of the second dividing line and a light receiving signal corresponding to the sub region allocated on one side of the first dividing line and the other side of the second dividing line.

The present invention also provides an optical pickup apparatus configured to access an optical disc including a recording layer including wobbled spiral or concentric track comprising a light source, an object lens which focuses a laser beam emitted by the light source to the recording layer of the optical disc, a hologram which includes four sub regions divided by a first dividing line which has a first direction corresponding to radial direction of the optical disc and a second dividing line which has a second direction orthogonal to the dividing line of the optical disc, a photo detector which includes plural light receiving elements receiving diffracting light from each sub region in the hologram and generating plural receiving light signals corresponding to each amount of receiving light, an information signal generating apparatus which generates an information signal including address information of the optical disc using the receiving light signal corresponding to each of the four sub regions, and a processing apparatus which retrieves an information recorded in the optical disc using an output signal of the information signal generating apparatus.

In this manner, in the case where the laser beam emitted from the light source is focused onto the recording layer on the optical disc through the object lens, the return light of the laser beam reflected back from the optical disc and through the object lens is deflected at the hologram having four sub regions divided by a first dividing line which has the direction corresponding to the radial direction of the optical disc and a second dividing line which is orthogonal to the first dividing line of the optical disc. The diffracted light from each sub region is received with plural light receiving elements composing the photo detector individually. The information signal generating apparatus generates the wobble signal from a difference with a sum signal of a receiving light signal corresponding to the four sub regions. In the conventional art, the information signal generating apparatus generates a signal including the address information using half of the return light of the laser beam. But in the present invention, because the information signal generating apparatus generates a signal including the address information using almost all of the return light of the laser beam, a S/N ratio of the generated signal is higher. Therefore, it is possible to detect the address information in the optical disc with high accuracy for plural kinds of the optical disc and it is also possible to access the optical disc stable.

### BRIEF DESCRIPTION OF THE DRAWINGS

FIG. 1 is a block diagram showing an optical disc drive related to a first embodiment of the present invention.

FIG. 2 is a schematic view of an optical pickup apparatus for the disk drive of FIG. 1.

FIG. 3A and FIG. 3B show holograms for the apparatus of FIG. 2.

FIG. 4 illustrates light receiving elements of a photo detector for the apparatus of FIG. 2.

FIG. 5 is a view showing a relation between a part of the hologram and a light receiving element of the photo detector.

FIG. 6 is a view showing an explanation of an information signal generating circuit described in FIG. 2.

FIG. 7A, FIG. 7B and FIG. 7C are views showing an explanation of the relationship between a wavelength of the light source and a spot diameter in the light receiving element.

FIG. 8 is a view showing an explanation of the relationship between a wavelength of the light source and the focusing error signal.

FIG. 9A, FIG. 9B and FIG. 9C are views showing an explanation of the relationship between a status of focusing and a spot shape on the light receiving element.

FIG. 10 is a view showing another example of the hologram described in FIG. 2.

FIG. 11 is a view showing an explanation of the relationship between a part of the hologram and a light receiving element of the photo detector described in FIG. 10.

FIG. 12 is a view showing an explanation of the disc which has the dual layer of the second embodiment of the present invention.

FIG. 13A and FIG. 13B are views showing explanations of a reflection light from recording layers without the target recording layer (flare).

FIG. 14 is a view showing a signal light and a flare when the target recording layer is M0.

FIG. 15A and FIG. 15B are views showing explanations of the hologram described in the second embodiment.

FIG. 16 is a view showing an explanation of the relationship between a part of the hologram and a light receiving element of the photo detector described in FIG. 15A.

FIG. 17 is a view showing a signal light and a flare when the target recording layer is M1.

FIG. 18 is a view showing a signal light and a flare on the hologram when the target recording layer is M0.

FIG. 19 is a view showing another example of the hologram described in second embodiment.

FIG. 20 is a view showing an explanation of the photo detector which can be used in correspondence with the hologram described in FIG. 19.

FIG. 21 is a view showing an explanation of the relationship between a part of the hologram described in FIG. 19 and a light receiving element of the photo detector described in FIG. 20.

FIG. 22 is a view showing an explanation of an information signal generating circuit using a part of the hologram described in FIG. 19 and a light receiving element of the photo detector described in FIG. 20.

FIG. 23 is a view showing another example of the photo detector described in FIG. 20.

FIG. 24 is also a view showing another example of the photo detector described in FIG. 20.

FIG. 25 is a view showing an explanation of an optical pickup apparatus described in the third embodiment.

FIG. 26 is a view showing an explanation of a photo detector described in FIG. 25.

FIG. 27A and FIG. 27B are views showing explanations of an information signal generating circuit described in FIG. 25.

### DETAILED DESCRIPTION OF PREFERRED EMBODIMENTS

### First Embodiment

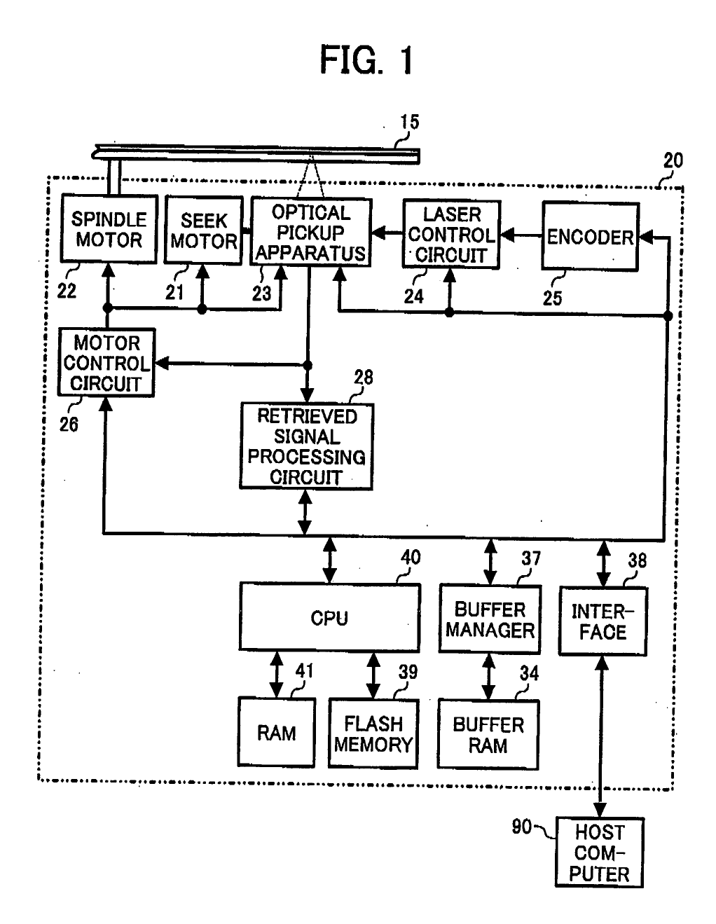

A description will now be provided of a first embodiment of the present invention with reference to the accompanying drawings (FIG. 1 to FIG. 6).

The optical disc drive 20 shown in FIG. 1 has a spindle motor 22 for carrying out a rotation drive of the optical disc 15, a seek motor 21 for moving an optical pickup apparatus 23 in a sledge direction, a laser control circuit 24, an encoder 25, a motor control circuit 26, a retrieved signal processing circuit 28, a buffer RAM 34, a buffer manager 37, an interface 38, a Flash ROM 39, a CPU 40, and a RAM 41. The arrows connecting the blocks in FIG. 1 show representative signal or information flow. The arrows do not show all connections of each block. An optical disc and an optical disc drive 15 described in the first embodiment are authorized of a standard of DVD series as one example.

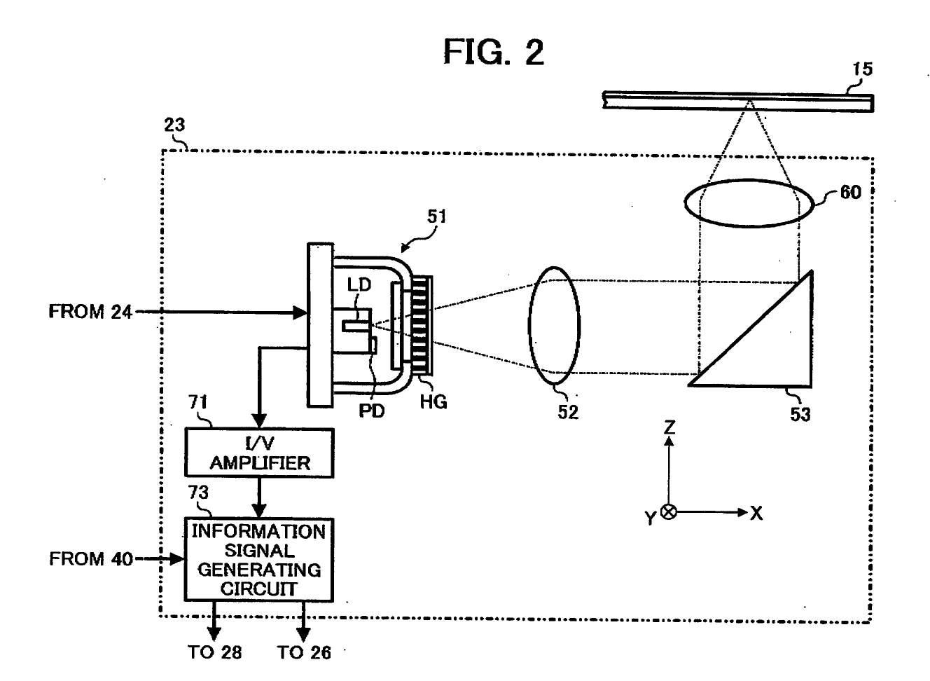

The optical pickup apparatus 23 is provided for receiving the return light from the recording surface of the optical disc 15, and for emitting laser beam to the recording surface of the optical disc 15. The disc 15 has at least one track as a data zone, to which data can be recorded and for receiving the laser beam that is reflected by the recording surface. As shown in FIG. 2, the optical pickup apparatus may have an emitting and receiving light unit 51, a coupling lens 52, a mirror 53, an object lens 60, an I/V amplifier 71, an information signal generating circuit 73 and a driving system (for example, a focusing actuator and a tracking actuator).

The emitting and receiving light unit 51 comprising a semiconductor laser diode as a light source emits about 660 nm wavelength laser beam, a photo detector PD deployed in the vicinity of the semiconductor laser diode as a light detector receives return light of the laser beam from the optical disc 15, a hologram HG divides a part of the return light of the laser beam to a photo detecting surface of the photo detector PD. This emitting and receiving light unit 51 is deployed as the maximum power emitting direction according to +X direction. The photo detector PD includes two or more light receiving elements, and is for outputting a signal containing wobble signal information, retrieved data information, focusing error information, tracking error information, etc. to the retrieved signal processing circuit 28. A driving system includes a micro driving system for producing a small amount of movement, and a coarse driving system for producing a large amount of movement. The micro driving system includes a focusing actuator for minutely moving the objective lens in the direction of the optical axis (the direction of focusing), and a tracking actuator for minutely driving the objective lens in the direction of tracking. The coarse driving system includes a seeking motor (coarse motion motor) for driving the main part of the optical pickup in the radial direction of the optical disc 15. The main part includes the semiconductor laser, the optical system, the optical receiver, and the micro driving system.

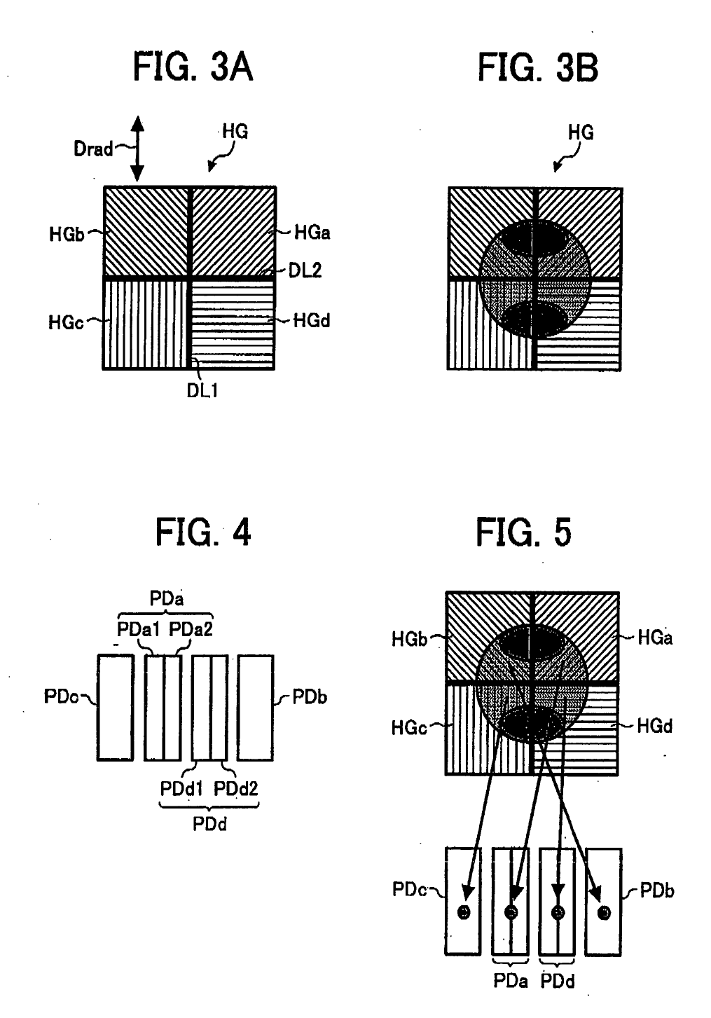

The hologram HG is divided into four sub regions, as shown in FIG. 3A and FIG. 3B, as one example, by a dividing line DL1 (first dividing line) which corresponds to the radial direction of the optical disc 15 (Drad, first direction) and a dividing line DL2 (second dividing line) which is orthogonal to the dividing line DL1 of the optical disc 15 (second direction). In this explanation using FIG. 3A, the upper-right side in FIG. 3A is defined to a sub region HGa, the upper-left side in FIG. 3A is defined to a sub region HGb, the lower-left side in FIG. 3A is defined to a sub region HGc, and the lower-right side in FIG. 3A is defined to a sub region HGd. Then, as described in FIG. 3B, one track pattern in the return light of the laser beam incident to the sub region HGa and the sub region HGb, and the other track pattern in the return light of the laser beam incident to the sub region HGc and the sub region HGd.

The photo detector PD has four light receiving elements (PDa, PDb, PDc and PDd), as shown in FIG. 4 as one example. In this explanation using FIG. 5, the light receiving element PDa receives light from the sub region HGa, the light receiving element PDb receives light from the sub region HGb, the light receiving element PDc receives light from the sub region HGc, and the light receiving element PDd receives light from the sub region HGd. The light receiving element PDa is divided into two light receiving elements PDa1 and PDa2 by a divided line which has the direction of Drad. The light receiving element PDd is divided into two light receiving elements PDd1 and PDd2 by a divided line which has the direction of Drad. A photoelectric converting signal (amount of receiving light signal) is supplied to the I/V amplifier 71 (FIG. 2) from the light receiving element PDa1, the light receiving element PDa2, the light receiving element PDb, the light receiving element PDc, the light receiving element PDd1 and the light receiving element PDd2 corresponding to each amount of receiving light.

The I/V amplifier 71 converts a photoelectric converting signal from photo detector PD to a voltage signal, and it amplifies this signal with a predetermined gain. In this case, a voltage signal Sa1 is defined to a voltage corresponding to a signal from light receiving area PDa1, a voltage signal Sa2 is defined to a voltage corresponding to a signal from light receiving area PDa2, a voltage signal Sb is defined to a voltage corresponding to a signal from light receiving area PDb, a voltage signal Sc is defined to a voltage corresponding to a signal from light receiving area PDc, a voltage signal Sd1 is defined to a voltage corresponding to a signal from light receiving area PDd1, and a voltage signal Sd2 is defined to a voltage corresponding to a signal from light receiving area PDd2.

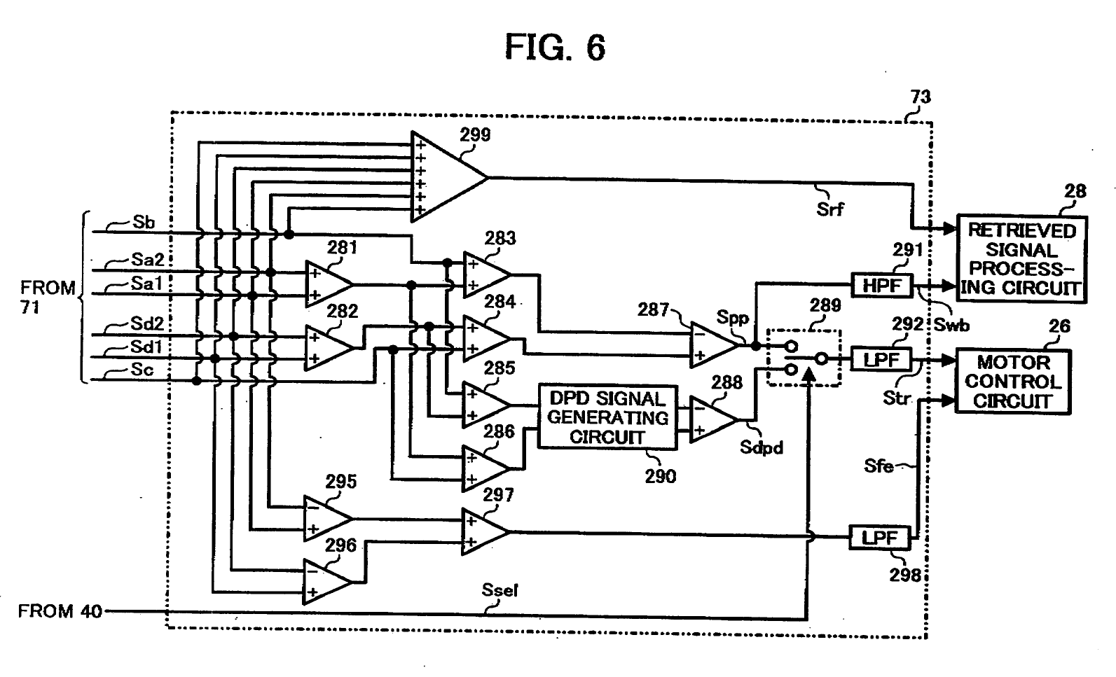

The information signal generating circuit 73 has eight accumulators 281, 282, 283, 284, 285, 286, 297 and 299, four subtractors 287, 288, 295 and 296, a switch 289, DPD signal generating circuit 290, a highpass filter (HPF) 291 and two lowpass filters (LPF) 292 and 298, etc. as shown in FIG. 6 as one example.

The accumulator 281 provides addition of the output signal Sa1 and the output signal Sa2 of I/V amplifier 71. The accumulator 282 provides addition of the output signal Sd1 and the output signal Sd2 of I/V amplifier 71. The accumulator 283 provides addition of the output signal Sb of I/V amplifier 71 and the output signal of the accumulator 281. The accumulator 284 provides addition of the output signal Sc of I/V amplifier 71 and the output signal of the accumulator 282. The subtractor 287 provides the difference signal of subtracting the output signal of the accumulator 283 from the output signal of the accumulator 284. The output signal of the subtractor 287 (PP signal) Spp is the same as (Sc+Sd1+Sd2)−(Sa1+Sa2+Sb). The HPF 291 extracts a high frequency component included in PP signal Spp, and provides an output signal as a wobble signal Swb to retrieved signal processing circuit 28. Therefore, the wobble signal Swb is generated by the output signal of I/V amplifier 71 corresponding to four sub regions of the hologram HG.

The accumulator 285 provides addition of the output signal Sb of I/V amplifier 71 and the output signal of the accumulator 282. The accumulator 286 provides addition of the output signal Sc of I/V amplifier 71 and the output signal of the accumulator 281.

The DPD signal generating circuit 290 generates two DPD signals based on a phase difference with an output signal of the accumulator 285 and an output signal of the accumulator 286. The subtractor 288 generates a difference signal of two DPD signals from DPD signal generating circuit 290. An output signal (phase difference signal) Sdpd from the subtractor 288 includes an information about a phase difference with an output signal of the accumulator 285 and an output signal of the accumulator 286.

The switch 289 selects one of the PP signal Spp or the phase difference signal Sdpd based on a signal Ssel from the CPU 40. In this case, the switch 289 selects the PP signal Spp when the optical disc is DVD+R, DVD+RW, DVD-R or DVD-RW, and selects the phase difference signal Sdpd when the optical disc is DVD+ROM.

The LPF 292 extracts a low frequency component included in the selected signal by the switch 289, and provides an output signal as a tracking error signal Str to motor control circuit 26. Therefore, the tracking error signal generated by push-pull method is extracted when the optical disc is DVD+R, DVD+RW, DVD-R or DVD-RW, and the tracking error signal generated by DPD method (phase differential method) is extracted when the optical disc is DVD+ROM. As above described, the tracking error signal Str is generated by the output signal of the I/V amplifier 71 corresponding to four sub regions of the hologram HG.

The subtractor 295 provides the difference signal by subtracting the output signal Sa2 of the I/V amplifier 71 from the output signal Sa1 of the I/V amplifier 71. The subtractor 297 provides the difference signal by subtracting the output signal Sd2 of the I/V amplifier 71 from the output signal Sd1 of the I/V amplifier 71. The accumulator 297 provides addition of the output signal of the subtractor 295 and the output signal of the subtractor 296. The output signal of the accumulator 297 is the same as (Sa1−Sa2)+(Sd1+Sd2). The LPF 298 extracts a low frequency component included in the output signal of accumulator 297, and provides an output signal as a focusing error signal Sfe to motor control circuit 26. As above described, the focusing error signal Sfe is generated using a double knife-edge method.

The accumulator 299 provides addition of the output signal Sa1, Sa2, Sb, Sc, Sd1 and Sd2 of I/V amplifier 71 and provides an output signal as an RF signal Srf to the retrieved signal processing circuit 28. Therefore, the RF signal Srf is generated by the output signal of the I/V amplifier 71 corresponding to four sub regions of the hologram HG.

The focusing actuator (not illustrated) is an actuator to drive the object lens 60 in the focusing direction which is an optical axis direction of the object lens 60. The tracking actuator (not illustrated) is an actuator to drive the object lens 60 in the tracking direction which is a radial direction of the optical disc 15.

As shown in FIG. 1, the retrieved signal processing circuit 28 receives the RF signal Srf from the information signal processing circuit 73 of the optical pickup apparatus, and the RF signal Srf is decoded by a decoding process, and an error detection process, etc., are carried out. If any error is found, the RF signal Srf is corrected by an error collecting process. Then, the RF signal Srf is stored in the buffer RAM 34 through the buffer manager 37 as retrieved data.

The retrieve signal processing circuit 28 acquires a kind of a disc based on a signal Ssel from the CPU 40, and detects a synchronizing signal or an address information etc. based on the wobble signal Swb from the information signal generating circuit 73 when the optical disc is DVD+R or DVD+RW. When the optical disc is DVD-R or DVD-RW, the retrieve signal processing circuit 28 extracts the land pre-pit from the wobble signal Swb, and detects a synchronizing signal or address information etc. based on the land pre-pit. When the optical disc is DVD-ROM, the retrieve signal processing circuit 28 extracts a synchronizing signal or address information etc. based on the RF signal Srf. In this case, the detected synchronizing signal is provided to the encoder 25, and the address information is provided to the CPU 40.

The motor control circuit 26 generates a driving signal of the tracking actuator to correct a position gap of the object lens 60 related to the radial direction of the optical disc 15 based on the tracking error signal Str from the information signal generating circuit 73 of the optical pickup apparatus 23. The motor control circuit 26 generates a driving signal of the focusing actuator to correct a position gap of the object lens 60 related to the focusing direction based on the focusing error signal Sfe. The generated driving signals are provided to the optical pickup apparatus 23. Therefore, it is possible to provide tracking servo and focusing servo. The motor control circuit 26 generates a driving signal to drive the seek motor and the spindle motor 22 based on the order from the CPU 40. Each drive signal is provided to the seek motor 21 and the spindle motor 22 respectively.

The data for record (recording data) and the data from optical disc (retrieved data) are stored in the buffering RAM 34 temporarily. The input and output process for the buffering RAM 34 is managed by the buffering manager 37.

The encoder 25 takes data from the buffering RAM 34 through the buffer manager 37 based on the order from the CPU 40, modulates the data, adds the error correcting code, and generates the writing signal to the optical disc 15. In this case, the generated writing signal is provided to the laser control circuit 24.

The laser control circuit 24 controls the power of the laser beam emitted by the semiconductor laser diode. In the case of recording to the optical disc, for example, the driving signal of the semiconductor laser diode is generated based on the writing signal, the recording condition and the luminescence properties of the semiconductor laser diode.

The interface 38 may be a bidirectional communication interface with the host computer 90. The interface 38 may be based on the standard such as ATAPI (AT Attachment Packet Interface), SCSI (Small Computer System Interface) or USB (Universal Serial Bus), etc.

The flash memory 39 includes a program area and a data area. In the program area of the flash memory 39, a program describing a decipherable code is stored with the CPU 40. And, in the data area, the recording condition or the luminescence properties of the semiconductor laser diode are stored.

The CPU 40 controls movement of the various parts according to a program stored by the program area of the flash memory 39, and the data needed for such control are saved in the RAM 41 and the buffering RAM 34.

In addition, when the optical disc is set, the CPU 40 detects a kind of the optical disc based on the reflectivity of the recording layer, servo followability, or the disc information stored in the optical disc 15, and provides the result of the detection process as the signal Ssel to the circuit whose process depends on the kind of the optical disc, for example, the information signal generating circuit 73 and retrieved signal processing circuit 28. Then the track error signal depending on the kind of the optical disc is provided from the information signal generating circuit 73. In addition, the retrieved signal processing circuit 28 detects the synchronizing signal and the address information depending on the kind of the optical disc when there is a request to access from the host computer, as previously described. And, based on the detected synchronizing signal and the address information, the object lens 60 is moved to the target position, and the optical disc is recorded or retrieved.

Thus, according to one aspect of the invention, the information signal generating means related to the first embodiment comprises the I/V amplifier 71 and the information signal generating circuit 73 in the optical pickup apparatus 23.

In addition, in the optical disc drive 20 related to the first embodiment, a processing unit comprises the retrieved signal processing circuit 28, the CPU 40 and a program carried out by the CPU 40. And it is preferable that some hardware be used to operate part of the program or all of the program.

As above described, according to optical pickup apparatus 23 related to the first embodiment, the laser beam emitted by the semiconductor laser diode (light source) is focused onto the recording layer of the optical disc 15 through the object lens 60. The return light of the laser beam reflected back from the optical disc 15 and through the object lens 60 is deflected at the hologram HG having four sub regions (HGa, HGb, HGc and HGd) divided by the dividing line DL1 (first dividing line) which has the direction corresponding to the radial direction of the optical disc 15 (Drad, first direction) and the dividing line DL2 (second dividing line) which orthogonal to the dividing line DL1 of the optical disc 15 (second direction). The diffracted light from each sub region is received by plural light receiving elements (PDa, PDb, PDc and PDd) composing the photo detector PD (light detector) individually. And the receiving light signal corresponding to the amount of receiving light is provided to the information signal generating circuit 73 through the I/V amplifier 71. The information signal generating circuit 73 generates the wobble signal from a difference with a sum signal of a receiving light signal corresponding to the sub region HGc and a receiving light signal corresponding to the sub region HGd, and a sum signal of a receiving light signal corresponding to the sub region HGa and a receiving light signal corresponding to the sub region HGb. The information signal generating circuit 73 generates the RF signal from a sum signal corresponding to four receiving light signals corresponding to four sub regions. In other words, even if the optical disc 15 is whichever of DVD+R, DVD+RW, DVD-R, DVD-RW and DVD-ROM, the information signal generating circuit 73 generates a signal including the address information using almost all of the return light of the laser beam. Therefore, it is possible to detect the address information in the optical disc with high accuracy.

In addition, the information signal generating circuit 73 generates the focusing error signal using a double knife-edge method. Thus, it is possible to generate the focusing error signal with the same accuracy of a focusing error signal using known art without decreasing the S/N ratio of the wobble signal.

And also it becomes possible to generate the track error signal corresponding to a kind of the optical disc because when the optical disc 15 is DVD+R, DVD+RW, DVD-R or DVD-RW, the information signal generating circuit 73 generates the track error signal with PP method, and when the optical disc 15 is DVD-ROM, the information signal generating circuit 73 generates the track error signal with DPD method.

And also according to optical pickup apparatus 23 related to the first embodiment, because the wobble signal and the RF signal which have high S/N ratio is generated by the optical pickup apparatus, the address information is detected with high accuracy even if the optical disc 15 is which of DVD+R, DVD+RW, DVD-R, DVD-RW and DVD-ROM. As a result, the object lens 60 is positioned with high accuracy. Therefore, it becomes possible to provide stable access for plural kinds of optical discs.

In addition, because the hologram is used, it becomes possible to miniaturize and reduce the weight and thickness.

Moreover, because the track error signal corresponds to a kind of the optical disc, it is possible to correct a position gap of the object lens 60 with high accuracy.

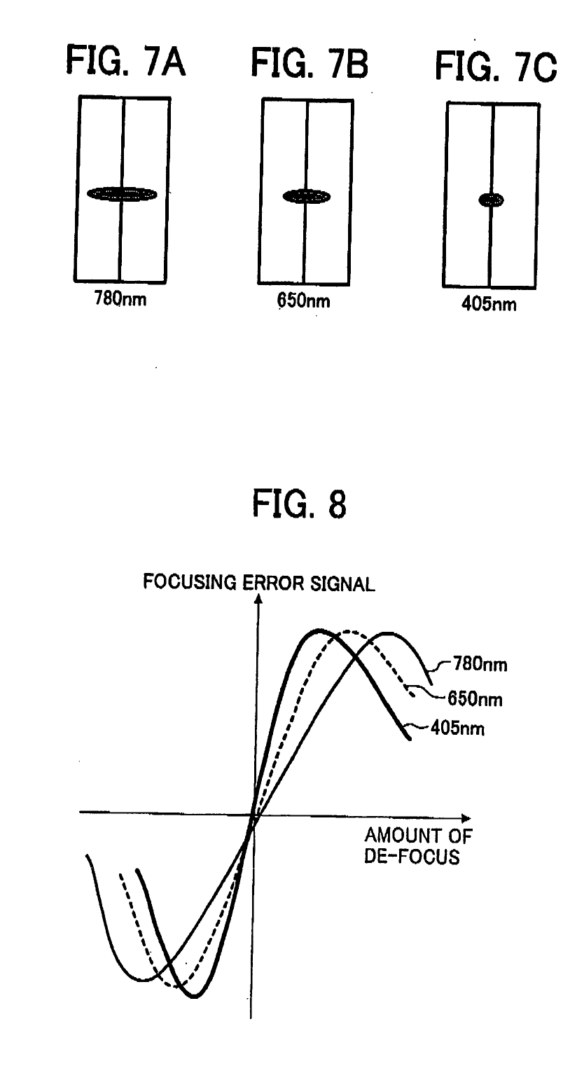

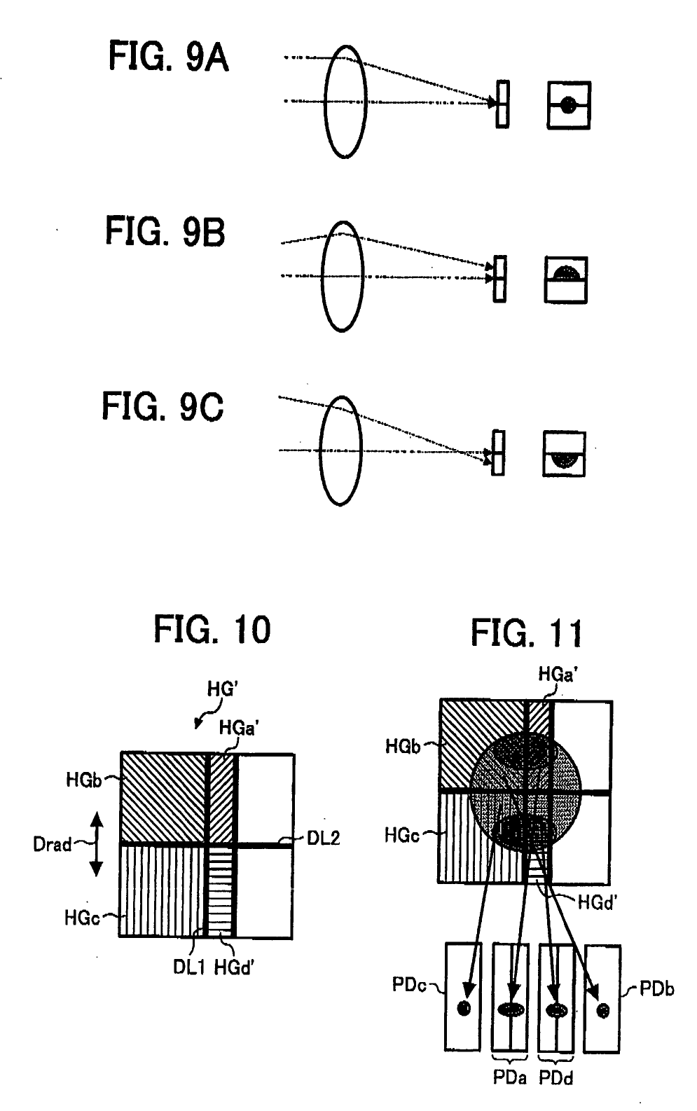

The light source wavelength may be as short as 780 nm (for CD), 660 nm (for DVD) or 405 nm (for Blu-ray) corresponding to the density of the optical disc. For example, as described in FIG. 7A, FIG. 7B and FIG. 7C, because the spot diameter on the light receiving element becomes small as the light source wavelength becomes short, the focus sensitivity becomes high as described in FIG. 8 for example. If the focusing sensitivity is high, a focusing pull-in range becomes narrow, and it is necessary to control dispersion of composing position for each part in the optical pickup apparatus. Furthermore, a focusing pullout happens easily due to vibration. Thus it is preferable to make focusing sensitivity low when the wavelength is shortened. For example, on the light receiving element, because an amount of the position shift of the light spot in a defocusing at a core of the light spot is shorter than an amount of the position shift of the light spot in a defocusing at an edge of the light spot as described in FIG. 9A, FIG. 9B and FIG. 9C, it is possible to decrease the focusing sensitivity to use the core of the light spot. Thus, if the hologram HG is replaced by a hologram HG′ which comprises a sub region HGa′ and a sub region HGd′, smaller than the sub region HGa and the sub region HGd, it is possible to make the spot diameter on the receiving light element bigger as described in FIG. 10 for example. In this case, the diffracted light from the sub region HGa′ is received with the light receiving element PDa, and the diffracted light from the sub region HGd′ is received with the light receiving element PDd. In the FIG. 10 embodiment, a part of the return light of the laser beam is not used, but because a part of track pattern which has a large amount of light power, is used, the effect for the signals are small.

### Second Embodiment

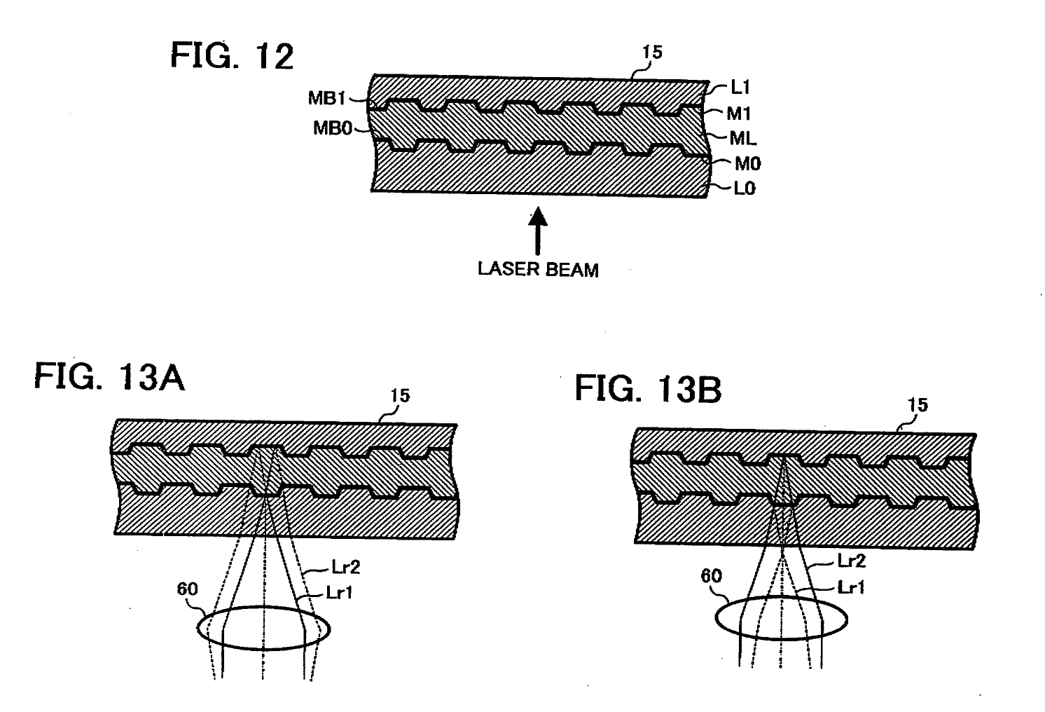

A description will now be provided of the second embodiment of the present invention with reference to FIGS. 12 through 18. The second embodiment is different from the previously described first embodiment in that an optical disc drive supports an optical disc having two recording layers (dual layer disc). Thus, in the following, it is described mainly in terms of differences with the first embodiment.

The optical disc 15 has a substrate L0, a recording layer M0, a middle layer ML, a recording layer M1, a substrate L1, from the side on which the laser beam is incident sequentially shown in FIG. 12 as one example. In addition, there is a half transmission membrane MB0 formed with silicon, silver and aluminum, etc. between the recording layer M0 and the middle layer ML, and there is a metal reflection membrane MB1 formed with silver, aluminum, etc. between the recording layer M1 and the substrate L1. Also, in the second embodiment, the optical disc 15 is a dual layer disc with the authority of a standard of DVD series, as one example.

Thus, the optical pickup apparatus 23 emits and focuses the laser beam into one recording layer (target recording layer) of two recording layers for access among the optical disc 15.

The return light of the laser beam from the optical disc 15 is described in the following.

When the target layer is the recording layer M0, the laser beam, emitted from the semiconductor laser diode, is focused on the recording layer M0 through the object lens 60 as shown in FIG. 13A for example. The laser beam reflected by the half transmission membrane MB0 (first reflected laser beam Lr1) is incident on object lens 60 as signal light. On the other hand, the laser beam reflected by the metal reflection membrane MB1 through the half transmission membrane MB0 (second reflected laser beam Lr2) is incident on object lens 60 as flare.

When the target layer is the recording layer M1, the laser beam, emitted from the semiconductor laser diode, is focused on the recording layer M1 through the object lens 60 as shown in FIG. 13B for example. The laser beam reflected by the metal reflection membrane MB1 (second reflected laser beam Lr2) is incident on object lens 60 as signal light. On the other hand, the laser beam reflected back with the half transmission membrane MB0 (first reflected laser beam Lr1) is incident on object lens 60 as flare. In other words, even if the target recording layer is either recording layer, the return light of the laser beam comprises a signal component light and a flare component.

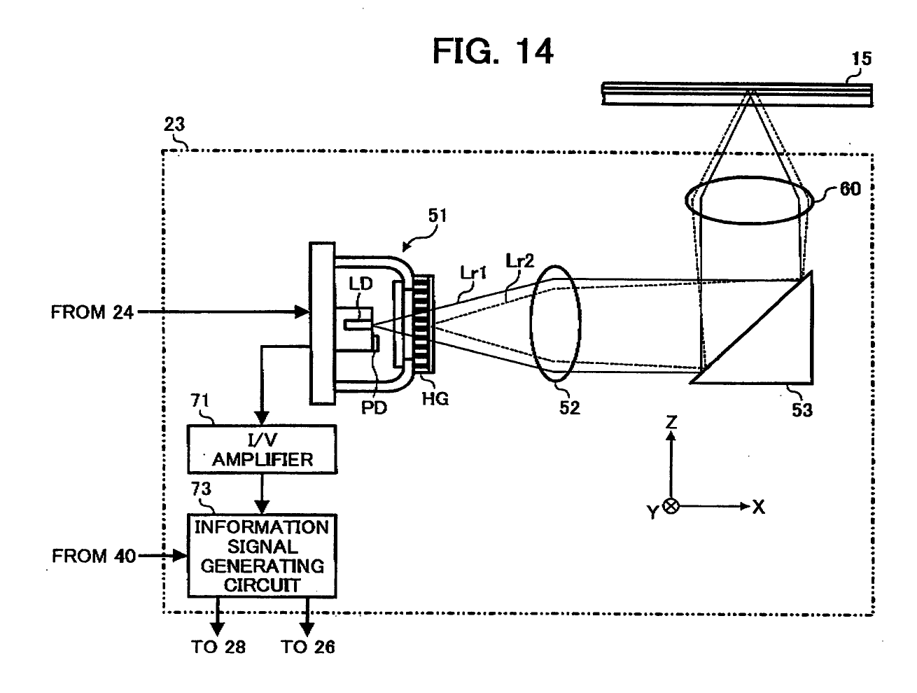

In particular, when the target layer is the recording layer M0, the flare component is focused around the hologram HG as shown in FIG. 14 as one example. If the flare component is incident on each sub region uniformly, the flare component is canceled by the information signal generating circuit 73. But when there is an optical axis gap by lens shifts of the object lens 60, a light spot of flare moves, so the incidence of the flare component in each sub region is non-uniform, and then it becomes difficult to cancel the flare component with the information signal generating circuit 73.

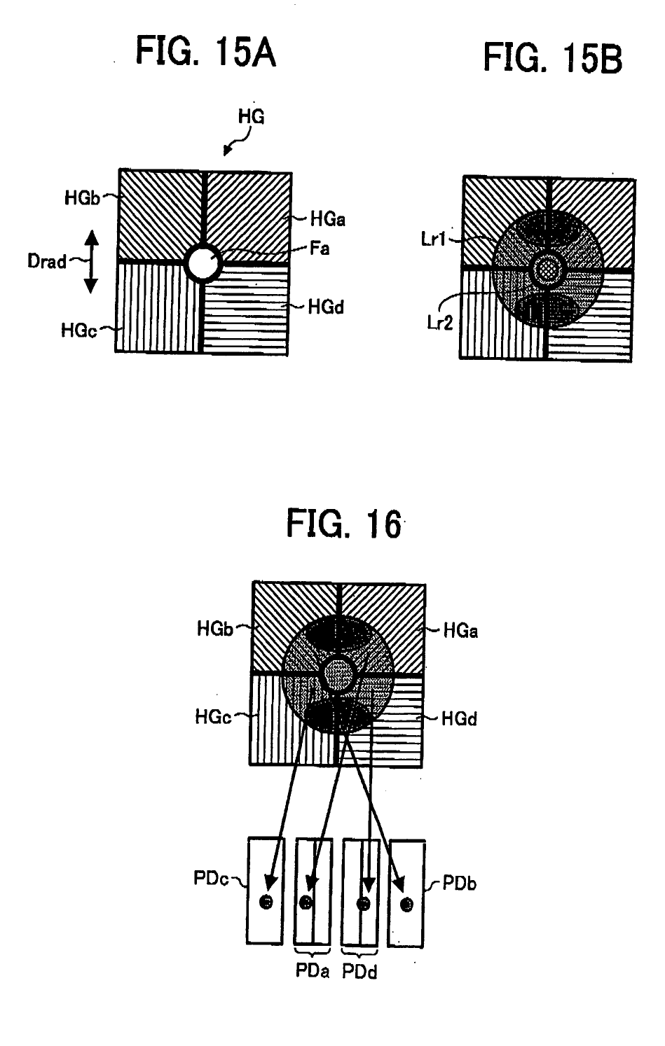

Thus, in the second embodiment, there is a new area (particular area) Fa for the flare component in and around the center of hologram HG as shown in FIG. 15A as one example. The size of the particular area Fa is bigger than a spot diameter of the flare on hologram HG as shown in FIG. 15B as one example. In addition, the shape of the particular area Fa does not need to be circular. And, the same as the first embodiment, the light receiving element PDa receives light from the sub region HGa, the light receiving element PDb receives light from the sub region HGb, the light receiving element PDc receives light from the sub region HGc, and the light receiving element PDd receives a light from the sub region HGd as described in FIG. 16. And, the same as in the first embodiment, the information signal generating circuit 73 generates each signals. Therefore, it become possible to reduce a noise caused by the flare to each generated signal with the information signal generating circuit 73.

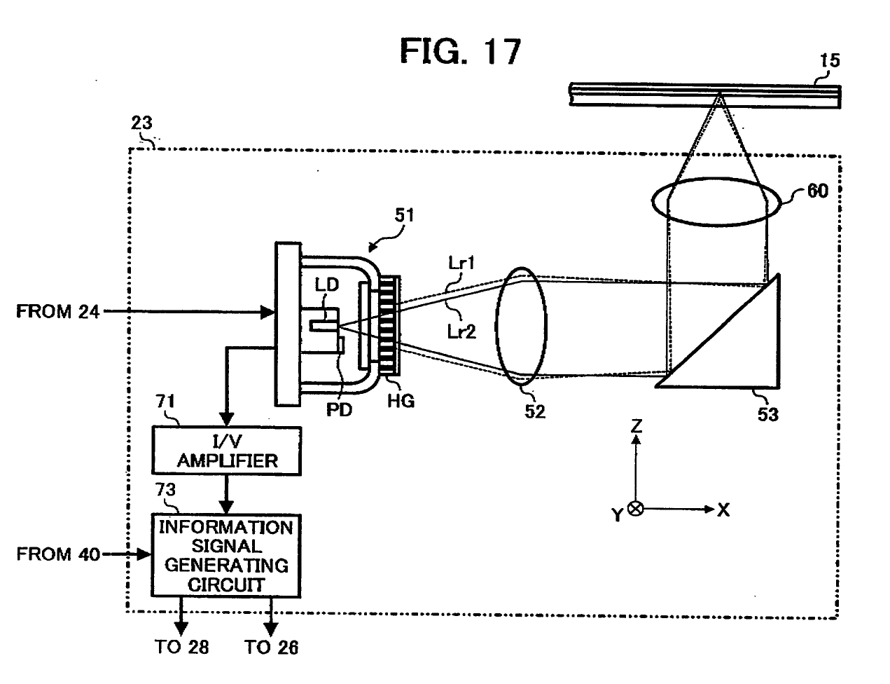

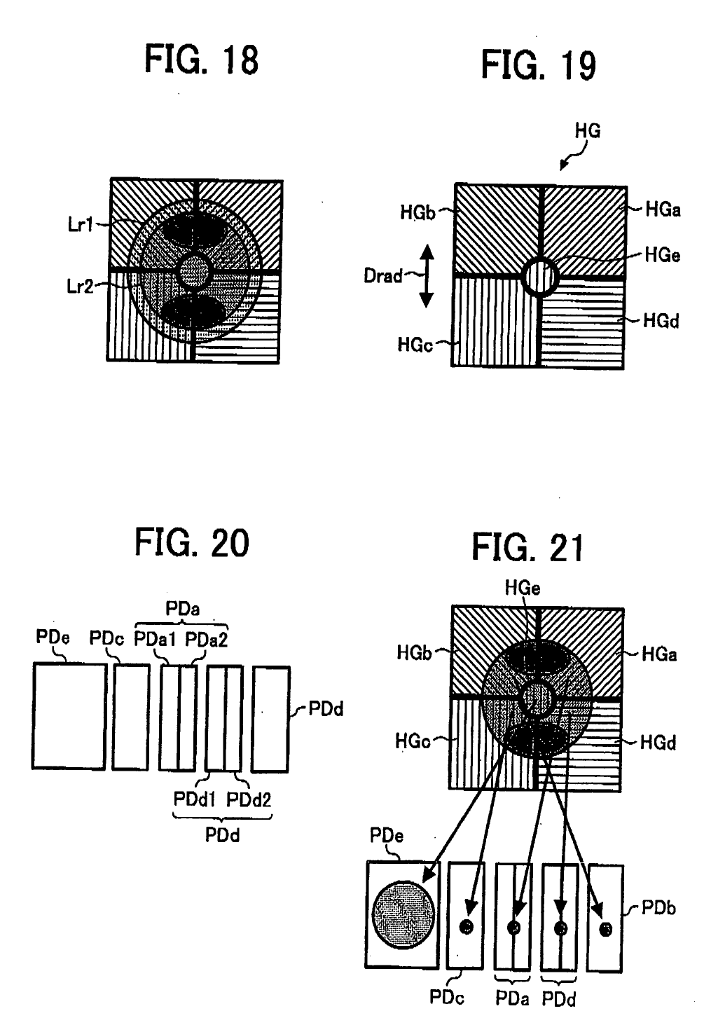

On the other hand, when the target recording layer is the recording layer M1, the spot diameter of the flare component in hologram HG (Lr1, in this case) becomes bigger than the spot diameter of the signal component (Lr2, in this case) as shown in FIG. 17 and FIG. 18 as one example. In this case, it is impossible to remove all of the flare component. But if there is an optical axis gap by lens shifts of the object lens 60, the big light spot moves inconsiderably. So each sub region always receives the flare approximately uniformly, and it is approximately canceled in subtraction with the subtractor of the information signal generating circuit 73. Therefore, it is possible to reduce a noise caused by the flare to each generated signal with the information signal generating circuit 73.

As above described, according to the optical pickup apparatus described in the second embodiment, because there is a new area (particular area) Fa to receive the flare component in and around the center of the hologram HG, if the optical disc has dual layers and if the recording layer of the access target is which recording layer, it is possible to reduce an effect of cross-talk between the layers for each signal generated in the information signal generating circuit 73. Therefore, it is possible to have the beneficial effects the same as the first described embodiment.

And also according to the optical pickup apparatus 23 related to the second embodiment, if the optical disc has dual layers, it is possible to have the same effect as the first described embodiment.

In the second embodiment, there is the particular area Fa for receiving the flare component, it is not limited. It is preferable to make a sub region HGe, which has a different diffraction direction from four sub regions HGa, HGb, HGc and HGd, at a position approximately the same as the particular area Fa as shown in FIG. 19.

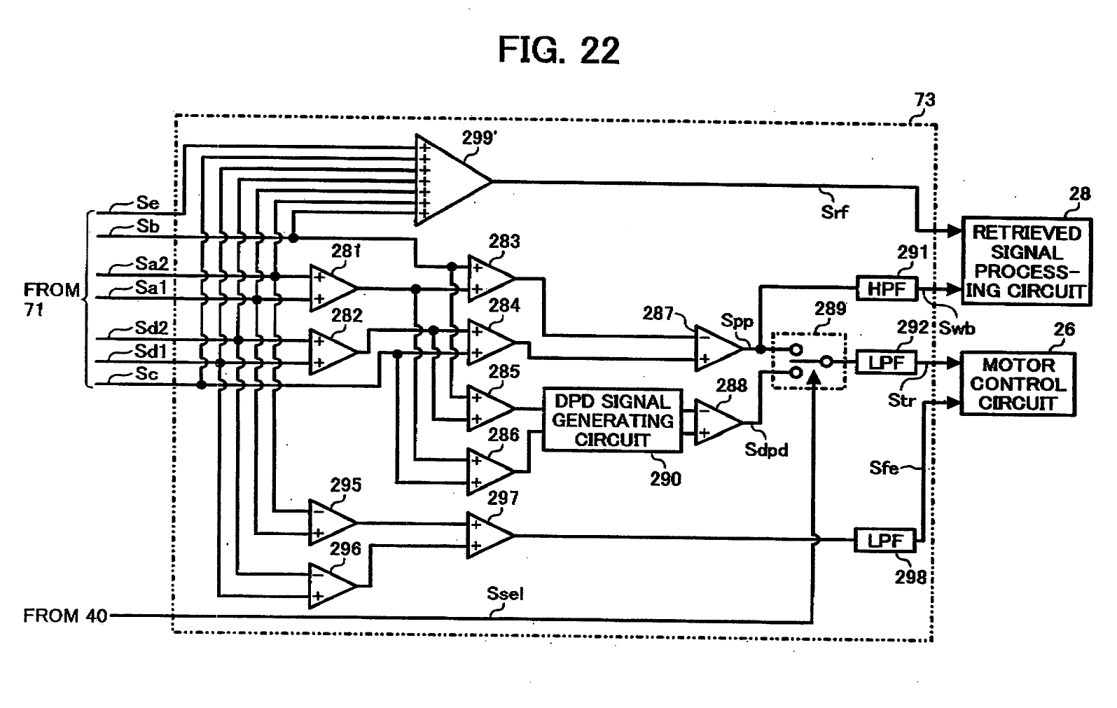

In this case, it is preferable to make new light receiving element PDe in the photo detector PD to receive the diffracted light from the sub region HGe as described in FIG. 20 and FIG. 21 for example. And it is also preferable to make an accumulator 299′ add an output signal Se of the I/V amplifier 71 corresponding to a signal from the light receiving element PDe instead of the accumulator 299 as described in FIG. 22. Therefore, it becomes possible to use the laser beam more efficiently for the RF signal.

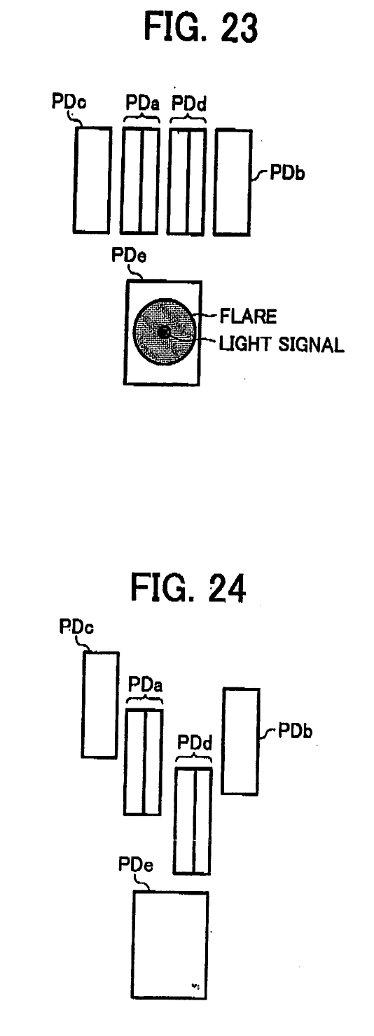

In addition, because the flare incident on the light receiving element PDe are in a defocused state, the flare becomes a big light spot on the light receiving element PDe. It is necessary for the light spot not to hang to the light receiving element aside from the light receiving element PDe. Thus, it is preferable to make the difference from the distance with the semiconductor laser diode and the other light receiving elements by distance with the semiconductor laser diode and the light receiving element PDe as described in FIG. 23 as one example. Especially, when the spot diameter of the flare is big, it is preferable to make the difference in each distance with the semiconductor laser diode and each light receiving elements as described in FIG. 24 as one example

In the above described second embodiment, the optical disc has two layers, but it is not limited. The optical disc may have three or more layers, if desired.

### Third Embodiment

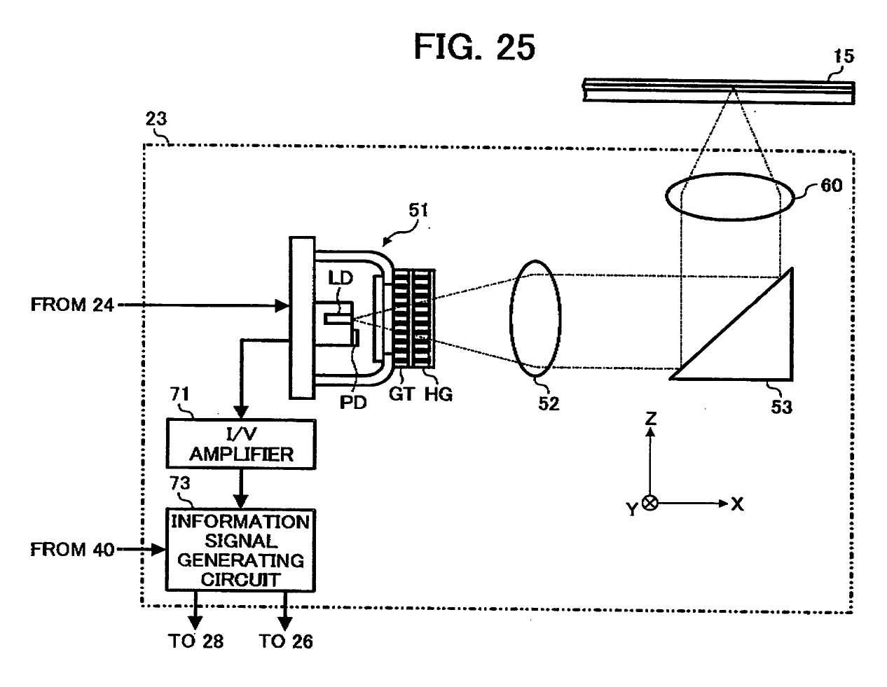

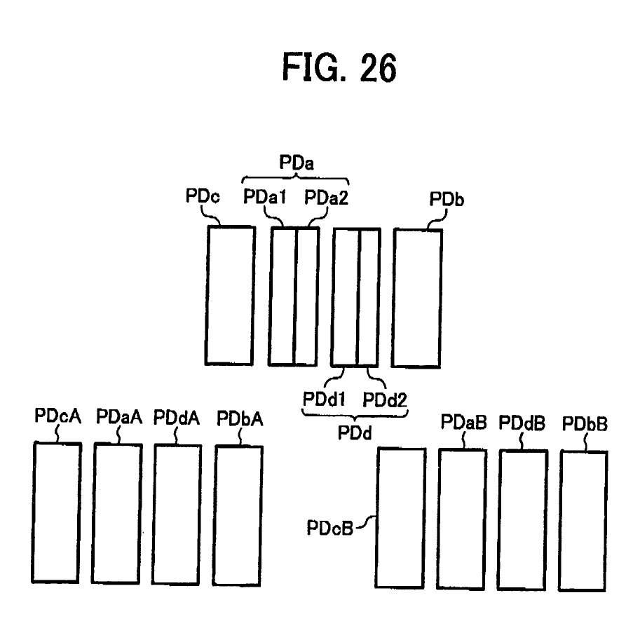

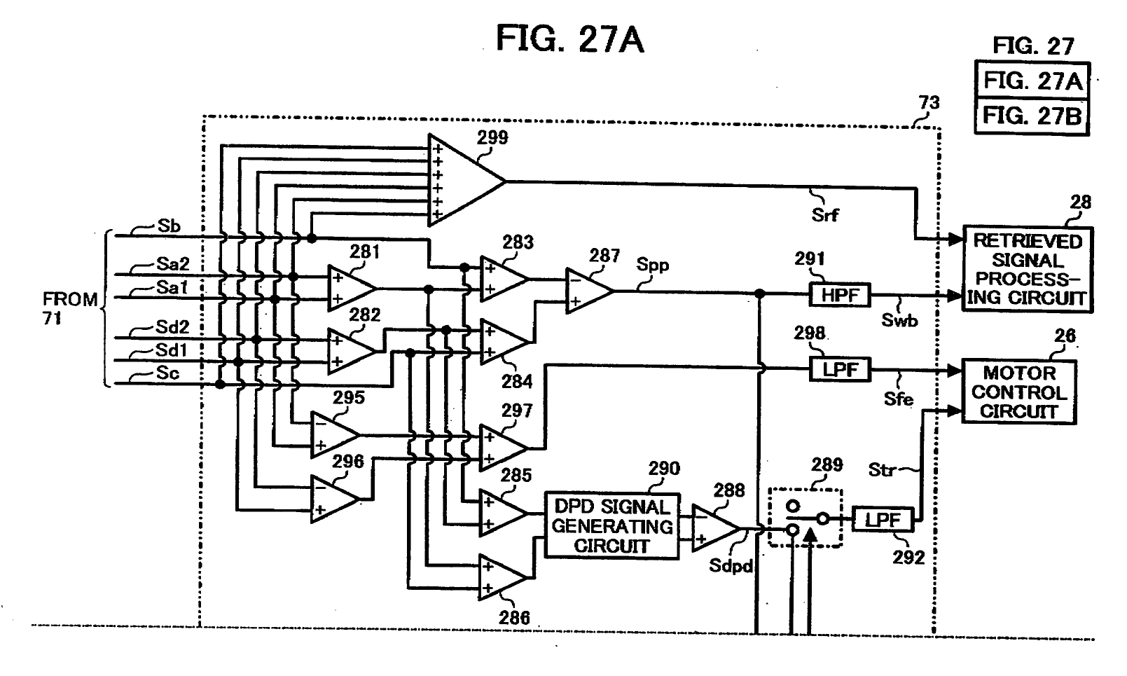

A description will now be provided of the third embodiment of the present invention with reference to FIG. 25, FIG. 26, FIG. 27A and FIG. 27B. The third embodiment is different from the first embodiment in that the information signal generating circuit 73 generates the track error signal with DPP method (differential push-pull method) when the optical disc 15 is DVD+R, DVD+RW, DVD-R or DVD-RW.

In the third embodiment, there is a grating GT for dividing a laser beam emitted by the semiconductor laser diode to one main beam (zero-order light) and two second beams (+1st and −1st order light) between the emitting and receiving light unit 51 and the hologram HG on the optical path as described in FIG. 25. In addition, the grating GT is set to make a light spot of +1st order light and a light spot of −1st order light deviated by ½ of the track pitch from the track as concerns a tracking direction on the recording layer of the optical disc 15.

Therefore, the return light of the laser beam of the zero-order light (first return light of the laser beam), the return light of the laser beam of +1st order light (second return light of the laser beam) and the return light of the laser beam of −1st order light (third return light of the laser beam) are incident on the hologram HG.

In addition, the photo detector PD has four light receiving elements (PDa, PDb, PDc and PDd) and eight more light receiving elements (PDaA, PDbA, PdcA, PDdA, PDAB, PDbB, PDcB and PDDB), as shown in FIG. 26 as one example. In this case, the light receiving element PDa, the light receiving element PDb, the light receiving element PDc and the light receiving element PDd receive the first return light of the laser beam from the hologram HG. The light receiving element PDaA, the light receiving element PDbA, the light receiving element PDcA and the light receiving element PDdA receive the second return light of the laser beam from the hologram HG, and the light receiving element PDAB, the light receiving element PDbB, the light receiving element PDcB and the light receiving element PDdB receive the third return light of the laser beam from the hologram HG. In addition, the light receiving element PDa, the light receiving element PDaA and the light receiving element PDAB receive the diffracted light from the sub region HGa, the light receiving element PDb, the light receiving element PDbA and the light receiving element PDbB receive the diffracted light from the sub region HGb, the light receiving element PDc, the light receiving element PDCA and the light receiving element PDcB receive the diffracted light from the sub region HGc, and the light receiving element PDd, the light receiving element PDdA and the light receiving element PDdB receive the diffracted light from the sub region HGd.

The I/V amplifier 71 converts a photoelectric converting signal from photo detector PD to a voltage signal, and it amplifies this signal with a predetermined gain. In this case, a voltage signal Sa1 is defined to a voltage corresponding to a signal from light receiving area PDa1, a voltage signal Sa2 is defined to a voltage corresponding to a signal from light receiving area PDa2, a voltage signal Sb is defined to a voltage corresponding to a signal from light receiving area PDb, a voltage signal Sc is defined to a voltage corresponding to a signal from light receiving area PDc, a voltage signal Sd1 is defined to a voltage corresponding to a signal from light receiving area PDd1, and a voltage signal Sd2 is defined to a voltage corresponding to a signal from light receiving area PDd12. In addition, a voltage signal SaA is defined to a voltage corresponding to a signal from light receiving area PDaA, a voltage signal SbA is defined to a voltage corresponding to a signal from light receiving area PDbA, a voltage signal ScA is defined to a voltage corresponding to a signal from light receiving area PDCA, a voltage signal SdA is defined to a voltage corresponding to a signal from light receiving area PDdA. A voltage signal SaB is defined to a voltage corresponding to a signal from light receiving area PDAB, a voltage signal SbB is defined to a voltage corresponding to a signal from light receiving area PDbB, a voltage signal ScB is defined to a voltage corresponding to a signal from light receiving area PDcB, a voltage signal SdB is defined to a voltage corresponding to a signal from light receiving area PDdB.

The information signal generating circuit 73 has eight accumulators 281, 282, 283, 284, 285, 286, 297 and 299, four subtractors 287, 288, 295 and 296, a switch 289, DPD signal generating circuit 290, a highpass filter (HPF) 291, two lowpass filters (LPF) 292 and 298, five accumulators 301, 302, 305, 306 and 309, and three subtractors 303, 307 and 310 etc. as shown in FIG. 27A and FIG. 27B as one example.

The information signal generating circuit 73 generates the PP signal Spp, the phase difference signal Sdpd, the focusing error signal Sfe and the RF signal Srf, same as the first embodiment.

The accumulator 301 provides addition of the output signal SaA of I/V amplifier 71 and the output signal SbA of I/V amplifier 71. The accumulator 302 provides addition of the output signal ScA of I/V amplifier 71 and the output signal SdA of I/V amplifier 71. The subtractor 303 provides the difference signal of subtract the output signal of the accumulator 301 from the output signal of the accumulator 302. The accumulator 305 provides addition of the output signal SaB of I/V amplifier 71 and the output signal SbB of I/V amplifier 71. The accumulator 306 provides addition of the output signal ScB of I/V amplifier 71 and the output signal SdB of I/V amplifier 71. The subtractor 307 provides the difference signal of subtracting the output signal of the accumulator 306 from the output signal of the accumulator 305.

The accumulator 309 adds the output signal of the subtractor 303 to the output signal of the subtractor 307. The subtractor 310 provides the difference signal of subtracting the output signal of the accumulator 309 from the output signal of the subtractor 287 (PP signal Spp). The output signal of the subtractor 310 (DPP signal Sdpp) is the same as {(Sc+Sd1+Sd2)−(Sa1+Sa2+Sb)}−{(ScA+SdA)−(SaA+SbA)}−{(ScB+SdB)−(SaB+SbB)}.

In the third embodiment, the switch 289 selects one of the DPP signal Sdpp or the phase difference signal Sdpd based on a signal Ssel from the CPU 40. In this case, the switch 289 selects the DPP signal Sdpp when the optical disc is DVD+R, DVD+RW, DVD-R or DVD-RW, and selects the phase difference signal Sdpd when the optical disc is DVD+ROM. Therefore, the tracking error signal generated by DPP method is extracted when the optical disc is DVD+R, DVD+RW, DVD-R or DVD-RW, and the tracking error signal generated by DPD method is extracted when the optical disc is DVD+ROM.

As above described, according to the optical pickup apparatus 23 related to the third embodiment, it is possible to have the same beneficial effects as the first embodiment in a 3 beam system.

And according to the optical disc drive 20 related to the third embodiment, it is possible to have the same effects as the first embodiment.

In addition, in each embodiment described above, it is preferable to use a polarizing hologram in which the diffraction efficiency is different depending on the polarized light direction of light incident on the hologram. A polarizing hologram can increase a signal component because a diffraction efficiency of the polarizing hologram is bigger than a diffraction efficiency of a non-polarizing hologram. Therefore, it becomes possible to use the laser beam more efficiently. But, in this case, it is necessary to set ¼ wavelength plate on the optical path between the emitting and receiving light unit 51 and the object lens 60. In addition, the polarizing hologram may be one of a variety of types, including but not limited to using liquid crystal, using double refraction crystallization and using an organic extension membrane.

In addition, in each embodiment, a blaze hologram may be used instead of the polarizing hologram. The blaze hologram can increase a signal component the same as using the polarizing hologram.

In addition, in each embodiment, it is preferable to generate at least one signal of the focusing error signal and the track error signal in the retrieved signal processing circuit 28.

In addition, in each embodiment, if there is no need to use DVD-ROM, it is preferable that there is no need to use the accumulator 285, 286, the DPD signal generating circuit 290, the subtractor 288 and the switch 289. In this case, the PP signal Spp is input into LPF 292. Furthermore, it is preferable to generate the RF signal Srf in the retrieved signal processing circuit 28.

In addition, in each embodiment, the optical disc drive could record and retrieve information, but the invention is not limited to the preferred embodiments described herein. It may be, for example, that the optical disc drive can perform at least one of record, retrieve and erase information.

In addition, in each embodiment, the optical pickup apparatus has one semiconductor laser unit, but it is not limited. The optical pickup apparatus may have plural semiconductor laser units which emit laser beams of several different wavelengths. In this case, it is preferable to include at least one of a semiconductor laser unit which emits 405 nm wavelength laser beam, a semiconductor laser unit which emits 660 nm wavelength laser beam and a semiconductor laser unit which emits 780 nm wavelength laser beam.

The entire disclosure of Japanese Patent Application No. 2004-117769, filed Apr. 13, 2004, is incorporated herein by reference.

1. An optical pickup apparatus configured to access an optical disc including a recording layer, said apparatus comprising:
a light source;
a hologram which includes more than two sub regions divided by a first dividing line which has a first direction corresponding to the radial direction of said optical disc and a second dividing line which has a second direction which is different than said first direction;
a photo detector which includes plural light receiving elements receiving diffracted light from each said sub region of said hologram and generating plural received light signals corresponding to each amount of received light; and
an information signal generating apparatus which generates an information signal including information of said optical disc using the light signals corresponding to said four sub regions.

2. The optical pickup apparatus according to claim 1, wherein said information signal including address information is a wobble signal.

3. The optical pickup apparatus according to claim 2, wherein said wobble signal is generated from a difference with a sum signal of said receiving light signal corresponding to said two sub regions allocated on one side of said second dividing line and a sum signal of said receiving light signal corresponding to said two sub regions allocated on the other side of said second dividing line.

4. The optical pickup apparatus according to claim 1,
wherein said optical disc is a multi-layer optical disc including plural recording layers;
wherein said hologram has a particular area which deflects return light from the recording layer which is located farther from said object lens than an accessing recording layer which is in a different direction compared to said four sub regions, or which is through a return light from the recording layer which is located farther from said object lens than an accessing recording layer to different direction compared with said four sub regions.

5. The optical pickup apparatus according to claim 4, wherein the size of said particular area is bigger than a spot diameter of said return light from the recording layer which is located farther from said object lens than said accessing recording layer on said hologram.

6. The optical pickup apparatus according to claim 1, wherein said information signal generating apparatus generates a signal including information retrieved from said optical disc using a sum signal of each light signal corresponding to said four sub regions.

7. The optical pickup apparatus according to claim 4,
wherein said photo detector comprises a light receiving element to receive a laser beam which is transmitted through said particular area or which is deflected by said particular area; and
wherein said information signal generating apparatus generates a signal including information retrieved from said optical disc using a sum signal of each said receiving light signal corresponding to said four sub regions and a receiving light signal corresponding to said particular area.

8. The optical pickup apparatus according to claim 7, wherein said light source and said photo detector are packed for one package.

9. The optical pickup apparatus according to claim 8, wherein a distance from said light receiving element receiving the laser beam which is transmitted through said particular area or which is deflected by said particular area to said light source is different with a distance from each said plural light receiving elements receiving diffracting light from each said sub region to said light source.

10. The optical pickup apparatus according to claim 1,
wherein two of said plural light receiving elements receiving said receiving light signal corresponding to said two sub regions allocated on one side of said second dividing line each have two sub light receiving elements dividing said first dividing line, and generate receiving light signals corresponding to the amount of receiving light for each sub light receiving element; and
wherein said information signal generating apparatus generates a signal including a position gap information of said object lens related to focusing direction.

11. The optical pickup apparatus according to claim 10, wherein said two sub regions allocated on one side of said first dividing line are smaller than said two sub regions allocated on the other side of said first dividing line.

12. The optical pickup apparatus according to claim 1,
wherein said information signal generating apparatus generates a signal including a position gap information of said object lens related to radial direction of said optical disc using
a difference between
a sum signal of two receiving light signals corresponding to said sub regions allocated on one side of said second divided line and
a sum signal of two receiving light signals corresponding to said sub regions allocated on the other side of said second divided line.

13. The optical pickup apparatus according to claim 1, wherein said hologram is a polarizing hologram in which the diffraction efficiency is different by a polarized light direction of light incident on a hologram.

14. The optical pickup apparatus according to claim 1,
wherein said information signal generating apparatus generates a signal including information about phase difference between
a sum signal of
a light receiving signal corresponding to said sub region allocated on one side of said first dividing line and one side of said second dividing line and
a light receiving signal corresponding to said sub region allocated on the other side of said first dividing line and the other side of said second dividing line and
a sum signal of
a light receiving signal corresponding to said sub region allocated on the other side of said first dividing line and one side of said second dividing line and
a light receiving signal corresponding to said sub region allocated on one side of said first dividing line and the other side of said second dividing line.

15. An optical disc drive configured to access an optical disc including a recording layer including wobbled spiral or concentric track, said optical disc drive comprising:
a light source;
an object lens which focuses a laser beam emitted by said light source to the recording layer of said optical disc;
a hologram which includes four sub regions divided by a first dividing line which has a first direction corresponding to radial direction of said optical disc and a second dividing line which has a second direction corresponding to orthogonal oriented to said dividing line of said optical disc;
a photo detector which includes plural light receiving elements receiving diffracting light from each said sub region in said hologram and generating plural receiving light signals corresponding to each amount of receiving light;
an information signal generating apparatus which generates an information signal including address information of said optical disc using the receiving light signal corresponding to each of said four sub regions; and
a processing apparatus which retrieves information recorded in said optical disc using an output signal of said information signal generating apparatus.

16. An optical pickup apparatus configured to access an optical disc including a recording layer including wobbled spiral or concentric track, said apparatus comprising:
a light source;
an object lens which focuses a laser beam emitted by said light source to the recording layer of said optical disc;
a hologram which includes four sub regions divided by a first dividing line which has a first direction corresponding to radial direction of said optical disc and a second dividing line which has a second direction orthogonal to said dividing line of said optical disc;
a photo detector which includes plural light receiving elements receiving diffracting light from each said sub region in said hologram and generating plural receiving light signals corresponding to each amount of receiving light; and
an information signal generating means for generating an information signal including address information of said optical disc using the receiving light signal corresponding to each of said four sub regions.

17. An optical disc drive configured to access an optical disc including a recording layer including wobbled spiral or concentric track comprising:
a light source;
an object lens which focuses a laser beam emitted by said light source to the recording layer of said optical disc;
a hologram which includes four sub regions divided by a first dividing line which has a first direction corresponding to the radial direction of said optical disc and a second dividing line which has a second direction orthogonal to said dividing line;
a photo detector which includes plural light receiving elements receiving diffracting light from each said sub region in said hologram and generating plural receiving light signals corresponding to each amount of receiving light;
an information signal generating means for generating an information signal including address information of said optical disc using the receiving light signal corresponding to said each four sub regions; and
a processing means for retrieving an information recorded in said optical disc using an output signal of said information signal generating means.

18. An optical pickup apparatus, comprising:
a device which includes sub regions divided by a first dividing line which has a first direction and a second dividing line which has a second direction different than said first direction;
means for receiving diffracted light from said sub regions and generating plural received light signals corresponding to the amount of received light; and
means for generating an information signal including information of said optical disc using the light signals.

19. A method of accessing an optical disc, comprising:
transmitting light onto a hologram which includes sub regions divided by a first dividing line which has a first direction and a second dividing line which has a second direction different than said first direction;
receiving diffracted light from each of said sub regions and generating plural received light signals corresponding to the amount of received light; and
generating an information signal including information of said optical disc using the received light signals.
